(19) United States
(12) Patent Application Publication
(10) Pub. No.: US 2015/0142690 A1
(43) Pub. Date: May 21, 2015

(54) METHOD AND APPARATUS FOR MASS UPDATES OF DIGITAL MEDIA

(71) Applicant: THOMSON LICENSING, Issy de Moulineaux (FR)

(72) Inventors: Ryan John Sorensen, Valencia, CA (US); William Gibbens Redmann, Glendale, CA (US)

(21) Appl. No.: 14/402,432

(22) PCT Filed: Nov. 26, 2012
(86) PCT No.: PCT/US12/66496

§ 371 Date: Nov. 20, 2014

Related U.S. Application Data
(60) Provisional application No. 61/653,129, filed on May 30, 2012.

(51) Int. Cl. G06F 17/30; G06Q 10/08

(52) U.S. Cl. CPC G06F 17/30174; G06F 17/3007; G06Q 10/083
USPC 705/330; 707/821; 707/610

(57) ABSTRACT

A method for providing a storage device with content files for exhibition commences by identifying, from a work order, a needed set of content files. Thereafter, a storage device, whose previously written content files most closely match the needed set of content files identified from the work order, is selected from an inventory of storage devices. The set of content files on the selected storage device undergo adjustment so that the storage device stores at least the needed set of content files. For example, if one or more of the needed set of content files are missing from the selected storage device, these files are replicated onto the selected storage device as part of the content file adjustment process.

### CROSS-REFERENCE TO RELATED APPLICATIONS

This application claims priority under 35 U.S.C. 119(e) to U.S. Provisional Patent Application Ser. No. 61/653,129, filed May 30, 2012, the teachings of which are incorporated herein.

### TECHNICAL FIELD

This invention relates to a technique for replicating digital media onto a storage device.

### BACKGROUND ART

Digital cinema requires the distribution of large amounts of digital content to exhibition facilities (e.g., movie theatres). While some facilities can accept satellite or other broadband delivery, the majority of digital cinema exhibitors, including those newly converting from film, will likely require to require the physical delivery of digital cinema content on storage devices (e.g., hard disk drives) for some time. Thus, each new movie release will require many hundreds of hard disk drives. Presently, most hard disk drives can accommodate a single movie. As hard disk drives increase in size, such drives will have the capability of storing multiple movies. Not every movie theatre plays a particular movie and only a fraction of theatres would play the same arbitrary combination of movies. Moreover, even if two or more theaters played the same combination of movies, such theaters would not likely play the same advertisements and other preshow entertainment (quizzes, music videos, etc.) However, distribution of a uniform collection of current trailers for upcoming features remains desirable. In any event, when reprocessing hard disk drives from previous distributions, a substantial (but variable) portion of the content remains still useable, so only removal out-of-date ads and trailers becomes necessary, along with the addition of newly available trailers (and needed digital cinema presentation(s)) originating since the previous distribution date.

Present high-performance hard disk drive replicators, such as the King-Hit XG1060 manufactured by YEH Co., Ltd. of Japan, obtain peak duplication speeds by bulk copying track-to-track from a master hard disk drive disk to identically sized target (clone) drives. Nevertheless, this technique has limited effectiveness for high-speed replication of individual or short run hard disk drives. For instance, use of a King-Hit hard disk drive disc replicator necessitates a master hard disk drive of the same size as the target drive(s), which requires the incremental step of making and verifying the master hard disk drive from files stored by a content management system. This effectively doubles the creation time for a master hard disk drive and requires that the operator perform operations which can lead to errors, such as copying the wrong content folder to the master hard disk drive, or grabbing the wrong master drive for a duplication run. After creation of the master hard disk drive, the bulk replication process copies the entire drive, even if data only exists on a portion of the drive, which again can lead to doubling of copy times (as compared to the time required when the new data occupies only a portion of the drive). The King-Hit hard disk replicator offers a mechanism to address this problem, but such a mechanism requires a complete read of the master hard disk drive first, which means that the benefit only accrues to a second batch of target drives, not the first batch, so that small runs cannot benefit from this feature.

One mechanism available to improve the speed of the bulk copy is “drive clipping” (also known as “Host Protected Area” or HPA), where a physical hard disk drive undergoes re-programming to resemble a smaller sized drive. However, this method requires clipping of both the master hard disk drive and all the target drives to the same size. The master hard disk drive undergoes clipping in advance and then undergoes partitioning and formatting to provide sufficient storage capacity for the content slated for distribution. The King-Hit hard disk drive replicator can then clip all the target drives to match the master drive prior to beginning bulk replication. This approach incurs the drawback of requiring the operator perform additional steps, as well as the increased likelihood of operator errors introduced by the clipping process, as well as errors likely to arise during subsequent use of the master or target hard disk drives during the “unclipping” process. Clipping introduces a further constraint that if the content files need updating or a need exists to add more content files, thereby increasing the storage space requirements. Thus, the clipped master hard disk drive might now lack sufficient storage capacity to accommodate the incremental content, thus introducing additional error.

Thus, a need exists for a system that better manages the copying of content files to a data storage device (e.g., a hard disk drive) drive for shipment to a particular theatre, so that theatre receives the correct content and the necessary copying and shipment occur efficiently with low risk of failure due to technical faults or operator error.

### BRIEF SUMMARY OF THE INVENTION

Briefly, in accordance with a preferred embodiment of the present principles, a method for providing a storage device with content files for exhibition commences by identifying, from a work order, a needed set of content files. Thereafter, a storage device, whose previously written content files most closely match the needed set of content files identified from the work order, is selected from an inventory of storage devices. The set of content files on the selected storage device undergo adjustment so that the storage device stores at least the needed set of content files. For example, if one or more of the needed set of content files are missing from the selected storage device, these files are replicated onto the selected storage device as part of the content file adjustment process.

### BRIEF DESCRIPTION OF THE DRAWINGS

FIG. 1 depicts a block diagram of a system for booking, replicating and distributing storage devices with content files and method of use in accordance with a preferred embodiment of the present principles;

FIG. 2 depicts a detailed block diagram of a portion of the system of FIG. 1;

FIG. 3 depicts in flow chart form a process for collecting drive configuration data during operation of the system of FIG. 1;

FIG. 4 depicts a state diagram for each replication job executed by the system of FIG. 1;

FIG. 5 depicts a state diagram for each hard disk drive while residing in a drive bay in the system of FIG. 1; and,

FIG. 6 depicts a state diagram for the total hard disk drive life cycle in the system of FIG. 1.

### DETAILED DESCRIPTION

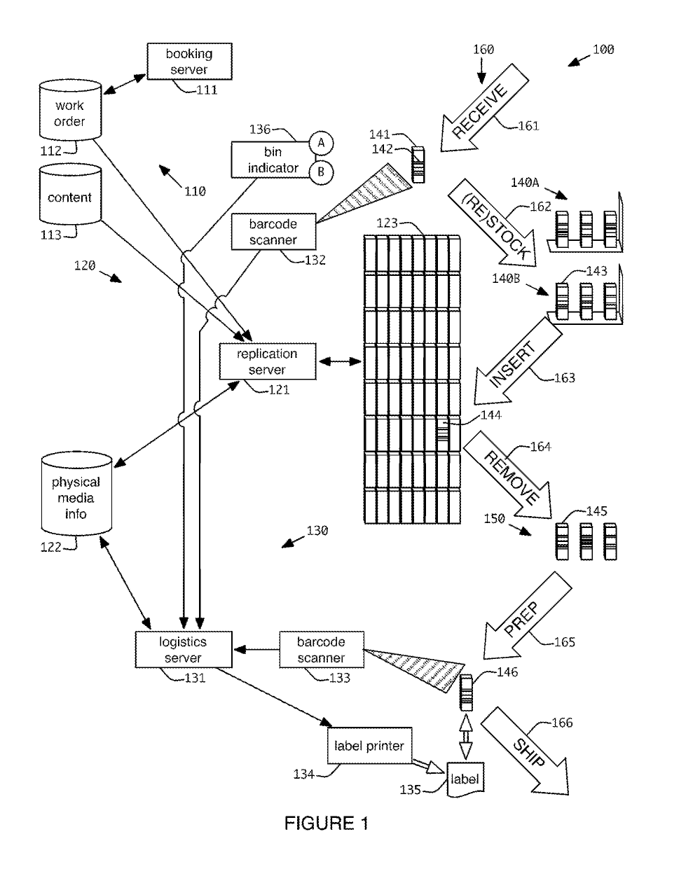

FIG. 1 shows a block diagram of a system 100 for booking, replicating and distributing content files (i.e., one or digital cinema presentations and/or ancillary information, such as trailers, announcements and/or advertisements), and an associated booking, replication and distribution process 160, both in accordance a preferred embodiment of the present principles. The system 100 comprises a booking system 110, a replication system 120, and a distribution system 130. Each of the booking system 110, replication system 120, and distribution system 130 will be described in the context of the overall system 100.

The booking system 110 comprises a booking server 111 and a work order database 112. Movie studios, other content owners, or agents for them, can all interact with the booking server 111 to enter work orders which specify the replication of one or more content files onto one or more storage devices (e.g., hard disk drives) for distribution to one or more movie theaters. A typical interaction between a content owner or its representative and the booking system server 111 occurs when the content owner or its representative logs into the booking server 111 through a secure user interface typically over the Internet or another network or combination of networks (e.g., WAN(s) and/or LAN(s)). Using the booking server 111, the content owner or its representative can to log into a corresponding account and issue work orders for replication of specific content files associated with that account (i.e., content files which the account holder has the authorization to control replication). As mentioned, each work order identifies specific content files for replication onto one or more hard disk drives for distribution to specific site(s), typically motion picture theaters. A work order database 112 stores such work orders entered through the booking system server 111.

The replication system 120 comprises a replication server 121, and one or more replication arrays 123 for holding individual hard disk drives described hereinafter. Presently, hard disk drives remain the preferred storage media for distributing content to movie theaters, given their relatively high storage capacity, low cost and small size. However, technological developments could lead to other types of storage devices that could serve as suitable replacements for storing and distributing content files that include one or more digital cinema presentations and/or ancillary information such as trailers, announcements and/or advertisements. As will become better understood hereinafter, the replication system 100 and replication process 160 of the present principles could readily accommodate other storage devices as they become available by making use of a suitable replication array (not shown) to interface to such storage devices.

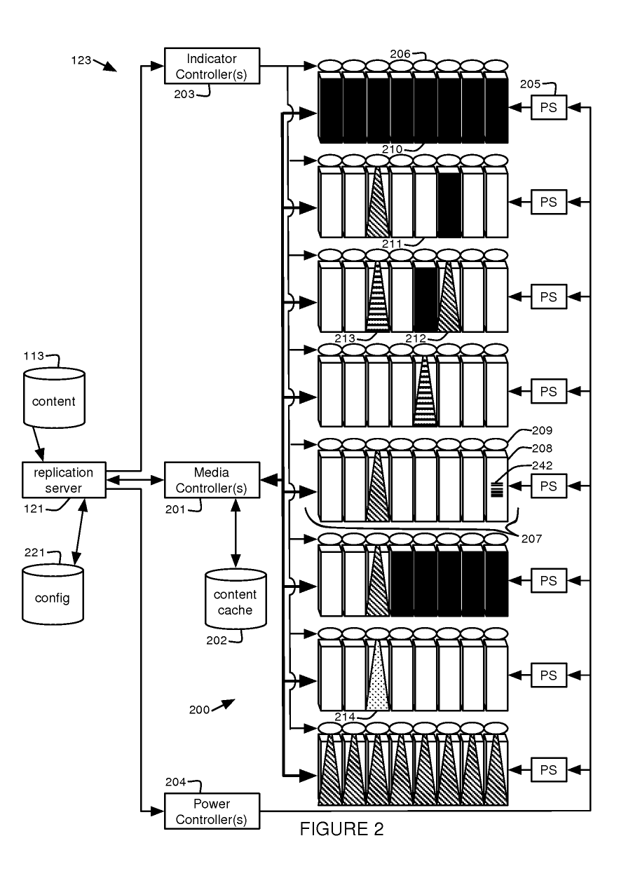

The replication server 121 accesses the work order database 112 since work orders serve to drive the operation of the replication system 120. The replication server 121 accesses a content store 113 comprising a network storage facility and/or an inventory of physical hard disk drives or other storage mechanisms for storing content files for replication onto the hard disk drives. Typically, the content files held by the content store 113 get preloaded by an ingest procedure, or the content files undergo creation for storage in the content store 113 through one or more post-production operations performed on previously unfinished content files. Alternative sources for content files could exist in place of, or in addition to the content store 113 as discussed further in conjunction with FIG. 2.

The booking system 110 can take different forms. For example, the booking system 110 could comprise the Theatrical Distribution System (TDS) offered by Cinedigm Digital Cinema Corp., of Morristown, N.J.. Alternatively, the booking system could comprise the Studio Portal offered by Technicolor Digital Cinema, of Burbank, Calif. Several major movie studios use one or more of these products for booking movies, while others have developed their own booking systems. The term “booking a movie” refers to the process of entering a work order to request replication of one or more content files (e.g., digital cinema presentations and/or ancillary information) onto one or more hard disk drives for shipment to one or more movie theaters. The replication of one or one or more content files onto a hard disk drive constitutes a replication job. Thus, a work order will specify at least one, and possibly multiple replication jobs.

Regardless of the specific type of booking system 110 that exists, the replication server 121 can access the resulting records (work orders) in the work order database 112 to determine the content files needed for specific destinations (movie theaters). In some embodiments, where multiple booking servers 110 exist, the work order database 112 will have one or more adaption layers (not shown), each providing an interface to the particular booking system. In an alternative embodiment, the multiple booking servers 110 could each have a corresponding work order database 112, in which case, the replication server 121 would have the ability to access each such work order database.

The replication server 121 has the ability to derive and prioritize replication jobs from the work orders in the work order database 112. Prioritization typically depends on many factors and can take account of due dates, delivery schedules, availability of content (e.g., the content existing in the content store 113), explicitly supplied work order priorities (e.g., a “rush” order), and/or work order priority policies (e.g., all things being equal, long-time customers take priority over new customers; large orders take priority over small orders). Regardless of the type and number of booking systems 110, the work order database 112 provides the interface between each booking system and the replication server 121 of the replication system 120. In particular, the replication server 121 uses information about previously used drives (e.g., drive 144) in the bays of a replication array 123 and those having been restocked (e.g., drive 143) in inventories 140A and 140B to improve replication efficiency as discussed in more detail below. Regardless of which or how many booking systems exist, the work order database(s) 112 serve as the interface between the booking system(s) 110 and the replication server 121 of the replication system 120.

The replication system 120 interfaces with the distribution system 130 at three places. First, the replication server 121 of the replication system 120 interfaces with the distribution system 130 though a physical media information database 122 used by both the replication server 121 and a distribution logistics server 131 to track the status of individual hard disk drives as described hereinafter. As will become better understood hereinafter, the physical media information database 122 stores information about each hard drive processed by the replication and distribution systems. Thus, the physical media information database 122 will store a record identifying the specific content files carried by a given hard disk drive, the record cross-referenced to the drive via identifying information, such as a disk drive serial number or the like.

Second, the distribution system 130 receives physical media, in the form of one or more hard disk drives 141 staged in the inbound inventories 140A and 140B for use by the replication server of the replication system 120. Third, hard disk drives such as the hard disk drive 145, already successfully written by the replication server of the replication system 120 according to a work order, are staged for shipment in an outbound inventory 150.

Generally, a work order takes the form of a list of content files for distribution and a list of one or more distribution targets (e.g., movie theaters) destined to receive those content files. Some work orders, or portions of them, can be fulfilled by electronic distribution (e.g., broadband or satellite transmission), depending upon the capability of the recipient movie theater to respond to the instructions of the booking entity. Electronic distribution systems exist separately and typically do not interface with the replication and distribution systems 120 and 130, respectively, described and illustrated herein.

Each work order can provide additional information, such as the show date and the length of run. From the show date, the replication server 121 can determine possible shipping dates, using rules based on the available shippers, classes of shipping (e.g., courier, next-day-first, next-day, second-day, etc.), and the corresponding costs. The possible shipping dates and costs constitute factors taken into account when optimizing the priority of individual replication jobs. A small job might undergo a delay and incur higher shipping costs so that a large job can complete in time to ship more inexpensively. The length of run constitutes an important piece used by a key generation system (not shown) to provide keys for each recipient movie theater to decrypt encrypted content for play out during the booked show dates. If a booking becomes subsequently extended, the key generation system will need to generate one or more new keys for an exhibitor, though generally no additional replication and distribution of content becomes necessary. Note that not all content requires encryption. Typically, only feature presentations undergo encryption but trailers or advertisements do not.

The distribution system 130 comprises a logistics server 131 that can access the physical media information database 122, and a set of barcode scanners 132 and 133 to read identifying indicia (e.g., a serial number) carried by the hard disk drives. Depending on the nature of the identifying indicia on each hard disk drive, devices other than the bar code scanners 132 and 133 could serve to identify a hard disk drive. The logistics server 131 also has access to one or more shipping label printers, such as label printer 134, for printing a shipping label 135 to identify the shipping location for a hard disk drive.

The replication and distribution process 160 generally proceeds in the following manner. An incoming storage device available for storage of content, e.g., the incoming hard disk drive 141, undergoes receipt in the replication system 120 during step 161 at which time, the bar code scanner 132 scans the identifying indicia 142 on the hard disk drive for registration by the logistics server 131. Depending on content previously written to drive 141, the logistics server 131 can instruct an operator to “restock” hard disk drive 141 in a particular inventory, for example using a bin indicator 136 which can signal which bin (e.g., bins ‘A’ and ‘B’ constituting inventories 140A, 140B, respectively) will hold the restocked drive. In addition to, or in the alternative, the restocked hard disk drives can carry a label indicating a predetermined inventory (e.g., inventories 140A or 140B) to which the hard disk drive belongs so that an operator can easily separate the drives upon receipt, which would reduce or eliminate the need for bin indicator 136. Separating the received hard disk drives into distinct inventories allows the replication server 121 to call for a particular inventory of hard disk drives for use, or otherwise cause like-purposed drives (e.g., drives carrying trailers) to populate the replication array 123 simultaneously, thereby making optimum use of caches within the replication server 121. The logistics server 131 can then update the status of a hard disk drive as “a ready drive” 143 as the drive undergoes restocking during step 162 into one of the inbound inventories 140A and 140B. These steps recur multiple times over the life of a hard disk drive each time an exhibitor returns a drive.

As needed, an operator can arbitrarily pull the “ready drive” 143 from either of the inventories 140A or 140B. Alternatively, the replication system 120 can request the operator pull the drive from a specific one of inventories 140A and 140B. The operator then inserts the “ready drive” 143 into the replication array 123 as an “in bay” drive 144 during step 163, where the drive remains while undergoing (a) purging of out-of-date content files, (b) writing of additional current content files, and (c) testing, all under the direction of replication server 121 in accordance with a replication job in an associated work order. The purging of out of date content files and the writing of additional files constitute the process of “adjusting” the content files on the hard disk drive so the drive will store at least the content files specified in the replication job of the associated work order.

Upon completion of the operations performed during step 163, an operator will remove the “in bay” drive 144 during step 164 and place the hard disk drive in the outbound inventory 150 as a “ship drive” 145 with a status set by the replication server 121 in the physical media information database 122 to indicate that the “ship drive”145 should ship to the destination specified in the corresponding work order in the work order database 112.

During step 165, the “ship drive” 145 undergoes preparation for shipment. Such preparation includes scanning the identifying indicia 142 on the “ship drive” 145 by the barcode scanner 133. In this way, the logistics server 131 can identify the “ship drive” 145 in order to access the information for that hard disk drive in the physical media information database 122 to retrieve the shipping information for transmission to the label printer 134 to produce a shipping label 135 for application to that drive and/or its shipping container. Once labeled in this fashion, the hard disk drive now becomes a “packaged drive”146.

During step 166, the “packaged drive” 146 undergoes shipment to the corresponding movie theater and the logistics server 131 updates the physical media information database 122 to set the status of the “packaged hard” drive 146 as “out.” The logistics server 131 can track the progress of drives listed as “out” by communication with information systems (not shown) operated by the shipping company contracted to ship the drive. Hard disk drives remain “out” until discovery of such drives when received during step 161.

FIG. 2 depicts a more detailed block diagram of content replication system 120 to illustrate components that comprise an exemplary configuration of the replication array 123. As depicted in FIG. 2, the replication array 123 comprises an array 200 of docking bays, some shown empty (e.g., the docking bay 210), whereas some contain a hard disk drive, like the docking bay 211. Each docking bay has an associated indicator, e.g., the indicator 206, in immediate, unambiguous physical proximity to the docking bay. Each indicator 206 indicates the status of the corresponding hard disk drive or the bay itself if empty. Each indicator 206 can be directly viewed, or can project light onto the drives itself (as shown).

Different animations and different colors convey status information to an operator having the responsibility of servicing the replication array 123. For example, a pulsing blue light can indicate a hard disk drive in a bay actively receiving content, whereas a steady green light 212 indicates a drive fully populated with content and ready for shipping. A blinking red indication 214 can identify a hard disk drive that has repeatedly failed quality tests and should be discarded. While the indicator 206 for a corresponding hard disk drive could provide many more details about the status of that drive, the indicator primarily provides an indication of what activity should occur next (e.g., “ship this drive”) or to warn against taking any action (e.g., “do not interrupt, this drive is being written”). The brightness or speed of an animation can convey a sense of urgency, e.g., a fast blinking green could represent a high priority shipment as compared to a steady green meaning “ready to ship” with normal priority.

An indicator controller 203 controls the individual indicators 206 responsive to commands from the replication server 121. Thus, as the replication server 121 updates the status of each hard disk drive or docking bay, the corresponding indicator 206 will reflect that change. Each docking bay has a corresponding power supply 205 which other docking bays can share. Each power supply 205 remains under the control of a power controller 204 responsive to the replication server 121. This allows the replication server 121 to save energy by powering down those hard disk drives in the array 123 not in use, as well as to power cycle hard disk drives as needed during certain drive initialization functions, e.g., drive clipping, also known as “Host Protected Area” (HPA).

The replication server 121 further controls one or more media controllers 201 connected to each hard disk drive bay in the array 200. Additionally, the replication system 120 can include a content cache 202, for example as a RAID (redundant array of inexpensive disks), so that when copying content to the hard disk drives in the array 200, the replication server 121 does not need to completely rely on the bandwidth available from its connection to the content store 113. In some embodiments, an operator could insert a master hard disk drive (not shown) into a designated docking bay in the array 200, and the replication server 121 could write content files from that master drive to target hard disk drives in other docking bays.

If needed, the replication server 121 can maintain a configuration database 221 that records the association between an individual docking bay (e.g., the bay 210), a corresponding individual indicator 206 and as needed, the corresponding controller 203 for that indicator, the media controller 201, and the power controller 204, and the appropriate port or other hierarchical designation within each device.

In one embodiment, the array 200 of docking bays comprises one or more sets of rack-mounted docking bays 207, the front panel of each of which has openings for eight docking bays, with each fillable by a drive as shown in FIG. 2. Each bay of each set of rack-mounted docking bays 207 has a barcode (not shown), corresponding to one of indicators above (e.g., the bay 210 has a bar code corresponding to the indicator 206 in proximity therewith). When lit, the indicator 206 may light for direct viewing or provide a beam 213 incident upon the corresponding docking bay. Each set of rack mounted docking bays 207 can may include human readable indicia (not shown), but should have machine-readable indicia for each drive bay (not shown), which can include striped barcodes or two-dimensional barcodes such as quick response (QR) codes. Such a QR code can represent information to identify the site, rack number, position number, and docking bay number of the corresponding docking bay. In this way, each docking bay has a unique identification regardless of its location within an enterprise, which can be useful when a need exists to address individual bays at multiple replication sites and distribution points for necessary throughput.

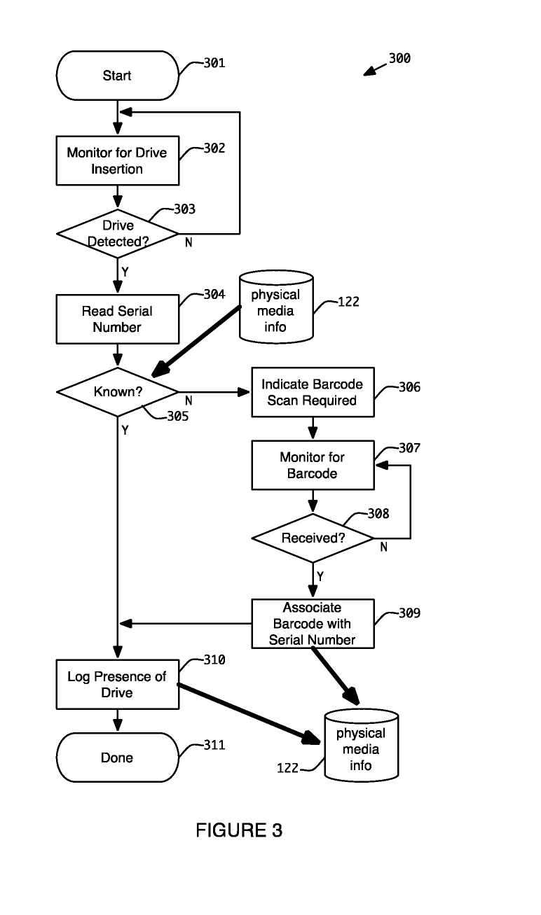

A configuration database 221 contains information about the configuration of the docking bays (e.g. bay 210) and the indicators (e.g., indicator 206) in the array 200 sufficient to run a drive-logging process 300 shown in FIG. 3. The process 300 of FIG. 3 begins at step 301 during which the replication server 121 of FIGS. 1 and 2 monitors for an indication that an operator has inserted a hard disk drive (e.g., hard disk drive 208 of FIG. 2) into the array 200 of FIG. 2. In some example embodiments, such monitoring can occur by having the replication server 121 periodically scan the hardware hierarchy, i.e., traversing the device paths for drives and looking for new entries. In an alternative embodiment, the process can receive a notification of the addition of a hard disk drive. If, during step 303 of FIG. 3, the replication server 121 of FIGS. 1 and 2 does not detect the addition of a hard disk drive, the process continues to wait during step 302 of FIG. 3, but if a drive has been added, then during step 304 server 121 will read the hard disk drive parameters to obtain its identifying information (e.g., the drive serial number) electronically.

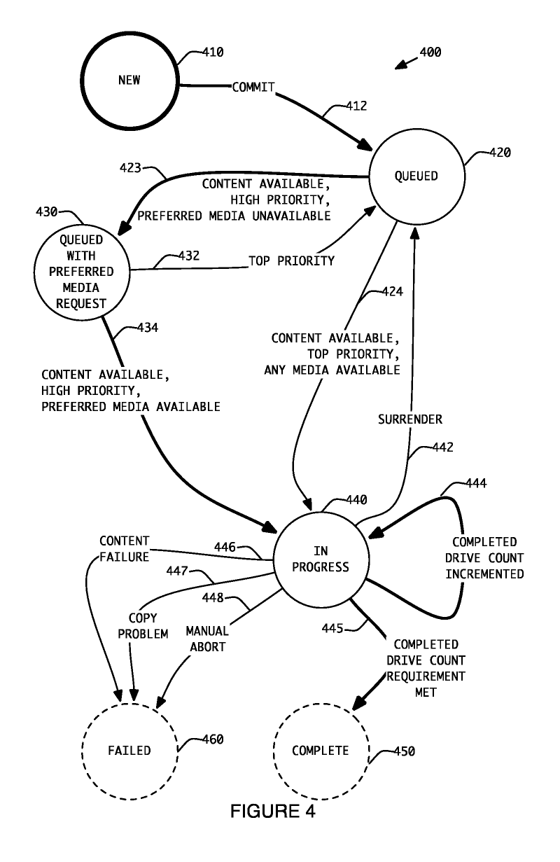

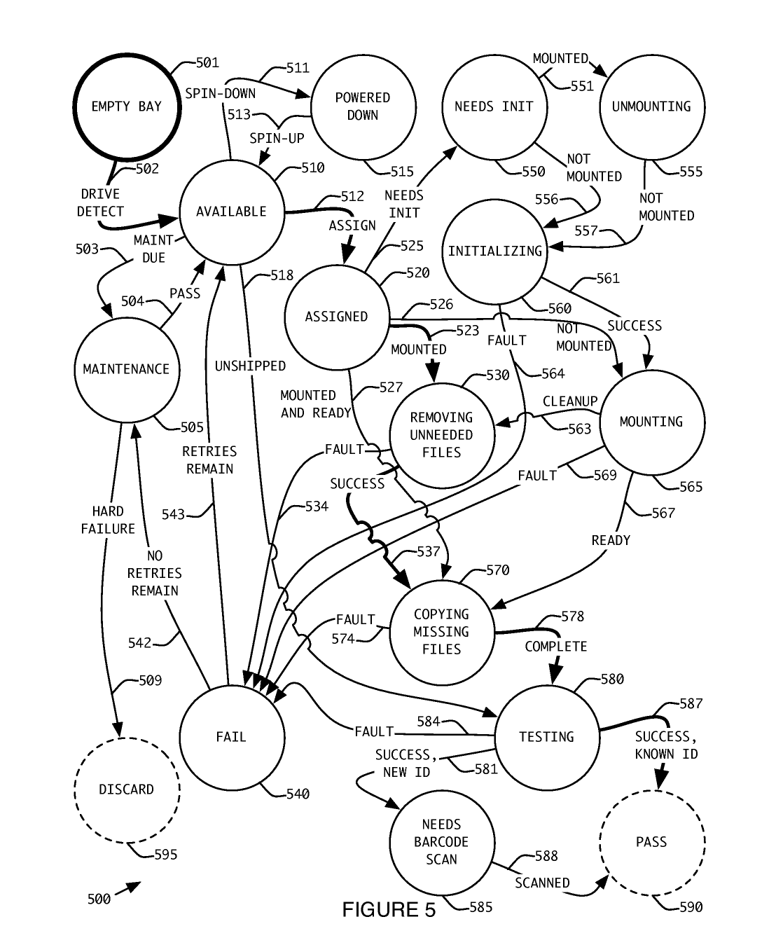

By querying the physical media information database 122, the replication server 121 can determine whether the replication system has previously registered the newly inserted drive. If so, processing continues at step 310 of FIG. 3, whereupon the replication server 121 of FIGS. 1 and 2 logs the hard disk drive in the physical media information database 122 of FIGS. 1 and 2 as being AVAILABLE, as discussed in greater detail in conjunction with FIGS. 4 and 5), and the process concludes at step 311 of FIG. 3. However, if during step 305, the serial number of the hard disk drive does not correspond to an entry in the physical media information database 122, then during step 306, the replication server 121 generates warning message indicating the need to scan the drive barcode, typically by flashing a corresponding indicator 209 with a color that indicates to an operator of the need to undertake a scan of the barcode 242 on the hard disk drive 208 in the corresponding docking bay. During step 307, the replication server 121 waits for the operator to scan the barcode (e.g., the bar code 242 in FIG. 2), looping back from step 308 until the scan occurs. Upon receipt of the barcode scan during step 309, the replication server 121 can extinguish the “scan needed” indication on indicator 209 and associate the drive serial number with the barcode by creating an appropriate record in the database 122.

In some cases, for example when multiple hard disk drives simultaneously indicate “scan needed,” the procedure could require an operator to scan both the docking bay barcode (not shown) and the drive barcode 242 to resolve the ambiguity as to the order for scanning multiple drive barcodes. Upon resolution of the “scan needed” condition, processing continues at step 310 of FIG. 3. In an alternative embodiment, instead of indicating the need to undertake a scan of the hard disk drive serial number during step 306, the replication server 121 could simply log the “scan needed” condition in the physical media information database 122 and processing would continue to step 310. In this way, an operator loading hard disk drives into the array 200 need not stop loading to scan barcodes before other duplication processes could proceed. Rather, operations performed on the hard disk drive (e.g., testing, and content addition and/or removal (i.e., content “adjustment”) could proceed with the replication system 120 not actually blocking progress until the drive becomes ready for removal for shipping. In such an embodiment, recognition by the replication system 120 of a “scan needed” condition could occur by energizing on the corresponding indicator, where the scan might come anytime while the drive remains in the array 200 of FIG. 2.

Once the “scan needed” condition becomes satisfied, the indicator could revert to whatever other state is pertinent. In still another embodiment, the “scan needed” indication could exist as a particular detail added to the other color and animation indications supported by the indicators. For example, the replication server 121 could indicate “scan needed” condition by a brief blue flash inserted into the color/flashing/animation the indicator currently shows.

In accordance with the present principles, the replication system 120 and the replication and distribution process 160 takes advantage of hard disk drives that store substantial number of content files appropriate to pending or future work orders when carrying out content replication to achieve greater efficiency. The manner in which the existing content on the hard disk drives plays a role in content replication will become better understood by reference to FIG. 4, which depicts a job state transition diagram 400 showing the progression of the various states through which a replication job typically proceeds. The acceptance of a work order entered from the booking system 110 into work order database 112 triggers the creation of a new replication job in the NEW state 410. Upon becoming committed during the transition 412, the replication job status enters the QUEUED state 420, and waits for the availability in the content store 113 of the content specified for the replication job by the associated work order.

If sufficient hard disk drives exist in the AVAILABLE state (following process 300 of FIG. 3) to satisfy the replication job, and the queued replication job has advanced to the top priority job, and the content specified is available in the content store 113, then the transition 424 advances the job to the IN PROGRESS state 440 and one-by-one, any drives assigned to the job (see FIG. 5) get prepared according to the work order, thereby incrementally reducing the number of additional drives required for the job during the transition 444. Once the number of hard disk drives required for the job have undergone successful copying, transition 445 advances the status of the replication job to the COMPLETE state 450. If, however, while the job remain in the IN PROGRESS state 440, a failure of the source content occurs during the transition 446 (e.g., the content checksums appear invalid), or a copy problem arises during the transition 447, (e.g., the content database 113 becomes unavailable), or a manual abort occurs the transition 448 (e.g., an operator cancels the work order), then the job transitions to the FAILED state 460. Once a replication job has entered the FAILED state 460, the job will need operator intervention (not shown) in order to be return to the QUEUED state 420. In some embodiments, if, while a first replication job remains in the IN PROGRESS state 440 and a sufficiently urgent second job enters the QUEUED state 420 and requires the media in use by the first job to run, the second replication job can commandeer the hard disk drive(s) obtained by the first job, such that the first job surrenders 442 the drive(s), and the first job returns to the QUEUED state 420.

Assignment of a hard disk drive to a replication job in the QUEUED state 420 may yield less than optimal results in the case where the hard disk drive(s) already available in replication array 200 contain few if any content files corresponding to those specified in the associated work order. In accordance with the present principles, a work order in the QUEUED state 420 becomes associated with one or more preferred hard disk drives, for example those drives stored in the inventory 140B (rather than in inventory 140A), on the basis that drives in inventory 140B have a higher statistical probability of storing content files reusable in conjunction with the current work order than those drives in other inventories (e.g., inventory 140A). The replication server 121 typically makes such an association from a comparison of the needed content files from the work order associated with the queued replication job, and the content files of each hard disk drive as last written by the replication system 120 and identified in a corresponding record in the physical media information database 122, or other database (not shown) storing such information.

For those the replication job(s) in the QUEUED state 420 and associated with a work order for which the content files are available, and which have high priority (but not the top priority), and for which one or more preferred hard disk drives expect to exist in a particular inventory (e.g., the inventory 140B rather than inventory 140A), a transition 423 places the replication job(s) in the QUEUED WITH PREFERRED MEDIA REQUEST state 430. The replication server 121 of FIGS. 1 and 2 will advise the operator of the pending high priority replication jobs efficiently handled by those hard disk drives from a particular inventory (e.g., inventory 140B). The operator will receive the request for hard disk drives from the particular inventory which should populate empty bays (e.g., bay 210) or those bays that become empty as drives get removed for shipment.

In some embodiments, if the time advantage of using one or more “preferred” hard disk drives warrants the additional labor, a particular indication by the indicator 206 can signal the operator to remove an as yet unassigned drive and set it aside (or return it to an inventory), so that the bay it occupies can receive a preferred hard disk drive instead. (A “preferred’ hard drive constitutes a drive having a higher statistical probability of carrying content files for an upcoming replication job.) The value of such an operation will become apparent when the number of reusable content files on the preferred hard disk drive represents a large fraction of the content files needed for a given replication a job, and those content files have long write times. Thus, re-using previously existing content files yields a correspondingly large savings in time. The savings in write time will grow as the size of hard disk drives and content file distribution increases.

Once a replication job associated with a work order enters in QUEUED WITH PREFERRED MEDIA REQUEST state 430 and at least one preferred hard disk drive becomes available, the transition 434 can take the job to the IN PROGRESS state 440, whereupon the system will preferentially select the preferred hard disk drives assigned to the job from the available pool preferred hard disk drives. Priority for assignment of a hard disk drive can consider which replication job can reuse the most number of content files, since that would represent the least amount of writing of new data across all available drives. When multiple replication jobs exist in the QUEUED WITH PREFERRED MEDIA REQUEST state 430, the priority of the replication job can consider the quantity of pre-existing content files on the current population of drives that matches the content files specified by the work order associated with the replication job(s), since the replication job making the greatest re-use of the available content would be a good choice for the next job to undertake the transition 434 to the IN PROGRESS state 440.

The replication system 120 can make use of more complex algorithms for selecting which multiple replication jobs in the QUEUED WITH PREFERRED MEDIA REQUEST state 430 would enhance overall hard disk drive replication efficiency. For example, the priority given to a job might consider the greatest number or size of new content files for writing to all of the hard disk drives assigned to that replication job, especially in a case where drives undergo writing in parallel and write speeds remain largely independent of the content files undergoing writing and the location of where such files get written. In such a case, the time needed to complete a replication job depends largely on the hard disk drive requiring the most writing. Thus, the time needed to complete a replication job is not substantially reduced by having some hard disk drives with radically more reusable content files. Hence, the priority of hard disk drives for assignment to a replication job requiring N drives would not substantially favor drives having substantially more reusable content files than that drive having the Nth most reusable content.

Further, the choice of which replication job(s) to advance next should take into account different combinations of jobs, with a goal of maximizing rates of completion so that the operator can ship drives as soon as possible. The choice of replication jobs could also depend on the expected completion time so that the most drives finish before the current operator shift expires, and then to move onto longer jobs that might run overnight, or though an unattended shift (or in the case of a large facility, that will run while the operator attends to other tasks or equipment).

Note that if a replication job lingers too long in the QUEUED WITH PREFERRED MEDIA REQUEST state 430, the job could reach top priority even if an operator has not loaded any preferred hard disk drive. In such a case, the replication job follows the top priority transition 432 back to the QUEUED state 420 and the replication job makes use of any available hard disk drive. Note that if the priority of such a replication job sufficiently exceeds one or more jobs already in progress, then the higher priority job can usurp hard disk drives from the lesser priority jobs already residing in the IN PROGRESS state 440 (and those jobs would surrender their hard disk drives during the transition 442). In this way, the hard disk drives always get well utilized and replication jobs get processed, while the replication system has the ability to respond to dynamic changes in priorities that can arise when a particular work order suddenly becomes very important.

FIG. 5 depicts a transition diagram 500 illustrating the various states of a hard disk drive processed by the replication system 120. The EMPTY BAY state 501 corresponds to an empty docking bay (e.g., bay 210 in FIG. 2). Following hard disk drive insertion, depicted by the occupied drive bay 211 in FIG. 2, the drive logging process 300 will detect that condition, causing the drive to follow the transition 502 to the AVAILABLE state 510 (corresponding to step 310 in FIG. 3).

While the drive bay status remains in the AVAILABLE state 510, a transition to MAINTENANCE state 505 becomes appropriate if the hard disk drive in that bay is not immediately needed and could reasonably accept maintenance or gets designated as needing scheduled maintenance, wherein the drive will undergo testing and/or conditioning. In practice, many hard disk drives possess Self-Monitoring, Analysis and Reporting Technology (SMART) thus allowing the hard disk drive itself to determine when maintenance becomes necessary. Alternatively, records kept by the physical media information database 122 tracking hard disk drive failures or aging can also serve to indicate the necessity of hard disk drive maintenance. If the hard disk drive passes testing, the drive undertakes a transition 504 to return to the AVAILABLE state 510. However, the hard disk drive fails and cannot recover (or in some embodiments, the drive fails a sufficient number of time, thereby comprising its integrity), then by transition 509 the drive enters the DISCARD 595 state. Under such circumstances, the replication server 121 of FIGS. 1 and 2 will set a corresponding indicator to alert the operator to dispose of the hard disk drive appropriately.

In some embodiments, an available but currently unneeded hard disk drive in an array filled with unneeded drives might spin-down by the power controller 204 during the transition 511 to save energy and wear, thereby entering the POWERED DOWN state 515. The hard disk drive will remain in that state until needed for a replication job whereupon the power controller 204 can spin-up those drives during the transition 513 and return them to the AVAILABLE state 510. Note that as such hard disk drives spin-down or spin-up, in some embodiments, the media controller 201 will report these events to the replication server 121 as a drive removal or insertion, respectively. The replication server 121 needs to track the status of hard disk drives treated in this way to appropriately manage the drives and their corresponding power controllers through the POWERED DOWN state 515. In particular, the replication server 121 needs to remember when an array becomes powered off with its then-current inventory of otherwise available hard disk drives. Even in the POWERED DOWN state 515, the corresponding indicators could show the hard disk drives as ready, typically by way of a dimmed and/or slower, version of the ‘ready’ indication.

When the replication job in one of the QUEUED states 420 and 430 has sufficient AVAILABLE drives during the transition 510 and the other requirements for the job become met to permit the corresponding one of the transitions 424 and 434, respectively, the replication server 121 will assign hard disk drives to that replication job as the job transitions to the IN PROGRESS 440 state. The hard disk drives associated with the replication job enter the ASSIGNED state 520 via transition 512.

Once a hard disk drive enters the ASSIGNED state 520, the replication server 121 could consider that the drive has too few or no reusable content files, or the dive has had too many uses since its last initialization (as determined by system policy) in which case the drive undertakes the transition 525 to the NEEDS INIT state 550. In some cases, the replication server 121 could determine directly or from the physical media info database 122 that the hard disk drive has undergone clipping to appear smaller than its actual physical size, and that the drive needs to undergo initialization to re-expand to a larger size demanded by the data for the current replication job, as discussed at length hereinafter.

From the NEEDS INIT state 550, the hard disk drive will enter UNMOUNTING 555 state if the drive was found previously mounted during the transition 551 (as can occur through certain testing or as in the normal state of drives when acquired by the operating system). Thereafter, the now un-mounted hard disk drive follows the transition 557 and enters the INITIALIZING 560 state. While a hard disk drive resides in the NEEDS INIT state 550 and the drive is already un-mounted, the dive can follow the transition 556 to the INITIALIZING state 560 directly.

While a hard disk drive resides in the INITIALIZING state 560, the replication server 121 will know the total data size “S_{DATA}” for the replication job at hand. There are several “sizes” that require consideration with respect to a hard disk drive in this state, which sizes have the following relationship:

S_{PHYSICAL}≧S_{CLIP}>S_{PARTITION}>S_{FILESYSTEM}>S_{DATA}

where “S_{PHYSICAL}” defines the total physical size of the drive. Some hard disk drives, if desired, can undergo “clipping” to a different, smaller size “S_{CLIP}” by setting an appropriate value for the host protected area (HPA). Drive clipping causes the hard disk drive to appear physically smaller to the operating system, which can make bulk copying with such systems more efficient (a “bulk” copy constitutes a copy made without knowledge of information structures on the disk, such as partitions and file systems). “S_{PARTITION}” corresponds to the size of the drive partition, which cannot exceed S_{PHYSICAL} (or S_{CLIP}, if set) and has a smaller value, due to space reserved for bad blocks and special records. The file system size, S_{FILESYSTEM}, again has a smaller value than the partition within which it resides, due to tables needed to for the structure of the partition itself. Finally, the structures of the file system (e.g., file allocation tables, Modes or the like) consume some amount of space, which ultimately constrains the size (S_{DATA}) of the data that will fit on the initialized hard disk drive.

Many systems gain an advantage by constraining the size of the partition, especially if S_{DATA} doesn't exceed about ⅔ of S_{PHYSICAL}. The advantage results from the fact that most hard disk drives spin at a constant speed and data cylinders at the outer radius of the disk can store more information than cylinders at the inner radius, which corresponds to the amount of data read or written during a single revolution of the disk. While the data transfer electronics of the hard disk drive can limit read and write rates that might otherwise be too fast for the outer cylinders, such electronics cannot sustainably speed up the slower data rates at the inner cylinders, making the outer portion of the drive (empirically observed on some models of some brands of drives to be the outer ⅔s) evenly performing, with incremental degradation when reading or writing to cylinders inward from there. Therefore, a smaller partition minimizes utilization of lower performing portions of the disk.

Another advantage accrues to a smaller partition when considering the behavior of certain file systems. The well-known FAT32 file system tends to write from the outer portion of the disk, to the inner portion, whereas the EXT2 file system prefers to space a new files as far as possible from previously written files, so as to better mitigate issues of file fragmentation when files get later deleted. This would lead to files being scattered throughout a partition, resulting not only in utilization of the inner cylinders, but also more magnetic head movement than would otherwise necessary. Therefore, in some cases, smaller partitions will minimize head movement when reading or writing a hard disk drive.

For these reasons, the processing occurring during the INTIALIZING state 560 can increase the job data size S_{DATA} by an amount (e.g., a predetermined percentage such as 2%, or predetermined amount such as 5 GB, or by a formula based on the particular file system type and parameters selected) to determine S_{FILESYSTEM}. That value can undergo an increase by an amount (e.g., a predetermined percentage or amount or a formula based on the partition type and parameters selected) to determine S_{PARTITION}. Finally, if desired, an appropriate clipping value S_{CLIP} may be selected. In generally, these time values get applied in reverse order: First, the drive undergoes clipping, then partitioning and formatting within the file system. A utility program, which in some cases may be manufacturer specific, performs clipping. Partitioning and formatting constitute utilities commonly provided by the operating system of the replication server 121.

For some operating systems, the process of clipping a drive can require that the drive undergo power-cycling, as by cycling the disk drive power supply 205 off and on to completely expunge the records of the drive's previous apparent size obtained from the media controller 201 and the operating system of replication server 121. FIG. 5 does not depict this condition which only arises for certain operating system/media controller/drive model combinations. However, in such cases, the required power cycling gets handled in much the same manner as a drive entering the POWERED DOWN state 511: The replication server 121 commands the power controller 204 to cycle power on the corresponding docking bay. Such power cycling causes the hard disk drive to disappear from the hardware hierarchy. Upon restoration of power (which can occur within a fraction of a minute), the operation system of the replication server 121 will recognize this hard disk drive. However, the replication server 121 has the responsibility of determining the device path and/or drive serial number corresponding to the hard disk drive undergoing clipping, so that the drive immediately returns to the INITIALIZING state 560 to continue that part of the process.

In some embodiments, setting of a default size for jobs relating to work orders of a particular class larger than the size required for the content files identified in the specific replication becomes desirable. This becomes especially true when the same drive is expected to be used many times, with a high percentage of content reuse each time, even if at the present time, the number of content files remains small compared to the expected peak. For example, the quantity of trailers can vary seasonally with peaks occurring at the beginning of the summer and the winter holiday season. In such a case, S_{FILESYSTEM} and encompassing structures can have a substantially larger size than the current value for S_{DATA}, and be set according to policies based on expected requirements over the life of this initialization, rather than the requirements for the immediate need.

In some embodiments, a hard disk drive in the INITIALIZATION state 560 can undergo an enlargement in size without erasing data currently on the device. For example, if a drive with a physical capacity of 2 TB becomes clipped to 1 TB and is formatted with a partition of about that size, and the new S_{DATA} is 1.5 TB, the drive could be reclipped to be a little larger than 1.5 TB. The partition on the hard disk drive could get rewritten to be that same size or slightly smaller, and many operating systems support resizing the file system without requiring a reformat or inducing any data loss on the disk.

If the initialization process fails then, via transition 564, the hard disk drive enters the FAIL state 540. However, if the initialization process is successful, then via transition 561, the drive and its new (or newly resized) file system mounts during in the MOUNTING state 565. Here, too, if a fault occurs, then transition 569 directs the hard disk drive to the FAIL state 540. If the mounting is successful and no files need removal (i.e., all the content files present remain reusable or the drive has just been completely formatted and no content files exist), then the drive becomes ready via the transition 567 and enters the COPYING FILES state 570. In circumstances in where reuse of some, but not all, content files can occur, then the drive requires cleanup and takes transition 563 to enter the REMOVING UNNEEDED FILES state 530.

If a hard disk drive in the ASSIGNED state 520 does not require initialization, then if already mounted, transition 523 advances the drive to the REMOVING UNNEEDED FILES state 530. If the newly assigned drive not needing initialization is currently un-mounted, the drive can follow the transition 526 to the MOUNTING state 565. While the hard disk drive resides in the REMOVING UNNEEDED FILES state 530, the replication server 121 removes files on the drive not needed for the replication job associated with that drive. If an unrecoverable fault 534 occurs during this process, the hard disk drive transitions to the FAIL state 540. Otherwise, success of the file removal will result in transition 537 when no more files need removal, causing the hard disk drive to enter the COPYING MISSING FILES state 570. In some cases, from ASSIGNED state 520, if the drive is already mounted and all the files on it are usable with the associated replication job, then transition 527 may be taken directly to COPY MISSING FILES state 570.

While a hard disk drive resides in the COPYING MISSING FILES state 570, the replication server 121 adds the files identified for the replication job assigned to that drive that are not already present. If one or more hard disk drives reside in COPYING MISSING FILES state 570 in association with the same replication job, or when more than one job references the same content file or content files, the replication server can employ different strategies to maximize the rate at which files undergo successful copying. Generally, if a large number of hard disk drives (say, fifty) copy the same large file, even if the drives start synchronously, their individual progress will diverge. The copy to the lead hard disk drive (the drive currently furthest ahead in copy progress) will always request portions of the file not yet cached, whereas other drives almost as far in copy progress gain a slight advantage with respect to the leader, insofar as their requests for the same portions get satisfied with less delay (because the portion of the file requested has already been requested by the hard disk drive furthest ahead, so the file portion will likely already exist in the content cache 202 of FIG. 2 or the fetch is already in progress). However, one or more hard disk drives will trail the pack of drives. Over the course of copying many thousands of sectors, the spread between hard disk drives will diverge such that the number of sectors between the sector currently requested for the lead drive and the sector requested for the trailing drive will just exceed the size of the content cache 202. At this instant, the next request made by a hard disk drive not in the lead group of the pack will correspond to a sector just purged from the content cache 202.

Typically, a hard disk drive cache operates on a least-recently-used (LRU) algorithm, so the no-longer-in-cache sector will likely correspond to the sector requested for the one drive having the greatest differential progress between its copy and the next more advanced drive so that a split occurs: The hard disk drives will divide into two groups, the lead group and the trailing group, each group having a lead drive (which may change frequently) always requesting an out-of-cache sector, and other drives receiving their sector data from the cache filled by the leader. Even so, the individual groups of hard disk drives can continue to spread, and either could potentially split again. Occasionally, a trailing group of hard disk drives can outpace the group ahead and suddenly find that its sector requests all reside in the content cache 202, and the groups merge. If this behavior remains unaddressed for a large copy job to a group of substantially identical disks, such behavior can lead to a portion of the disks finishing the copy job several minutes before later groups.

Providing enough RAM in the replication server 121, so that for a copy job of a particular size the size of the RAM cache available to the operating system will unlikely be exceeded, given the statistical rate at which a group's copy progress spreads out, represents one strategy to address the difference in copying times. Thus, over the course of copying 100 GB (an example sized copy job containing about 200 billion half-kilobyte sectors), in a group of N drives (e.g., 64), if the spread between the most advanced copy and the least advanced copy is not likely to exceed 5 GB (about 10 billion sectors), then providing and allocating 5 GB of RAM to the operating system for use as disk cache will substantially reduce gaps between the first and last finishing drives. Since more than one job can run at a time, increasing that allocation by a factor equal to the expected number of simultaneous jobs will prove useful. However, increasing the allocation provides a benefit only up to a certain point. For example, if 32 pairs of hard disk drives were assigned to 32 replication jobs), the pairs of drives would likely not diverge much since in each pair the leader always waits for a sector and the other drive always waits less, so little cache would be needed).

The replication server 121 could implement an alternative strategy, namely delaying the leaders of a group of hard disk drives slightly between individual file copies. For example, if a 100 GB job comprises 10 individual files, then as the leaders complete each file, their onset for copying the next file gets delayed until the trailing group catches up, or if a detailed analysis detects that it would be more efficient, then only until the trailing drives in the current group catch up. In this way, the replication server 121 of FIG. 1 can mitigate substantial splits in the content cache 202, and though the completion time of the first drive becomes extended, the completion time of the worst-case drive gets reduced. This strategy has value for an urgent job to avoid the need to call an operator to begin removing drives (e.g., operational step 164) until the replication job has completed.

In some instances, one or more hard disk drives will exhibit poor performance, in comparison to other drives in the same job. For example, consider the performance of a native 500 GB hard disk drive and a 1 TB disk clipped to 500 GB when copying almost 500 GB of content files. In such a situation, the native 500 GB hard disk drive might exhibit slower data transfer than the clipped disk, when writing content files to the last ⅓ or so of the smaller disk's cylinders. As a result, even the caching strategy discussed above will not keep the disk at the same performance level as the clipped disk. In such cases, the characteristics of the slower hard disk drive, whether currently observed while in COPYING MISSING FILES state 570, previously noted (e.g., in physical media information database 122), or anticipated from the drive's characteristics, the replication server 121 can drop the slower drive from the job (e.g. by triggering a fault during the transition 574 of FIG. 5), or perhaps by not assigning the drive to the job at the outset during the transition 512 of FIG. 5. Removing slow drives from jobs requiring large numbers of copies allows jobs to finish more quickly.

Assigning drives known to exhibit similar performance during the transition 512 will reduce performance drops due to progress spread that can defeat a caching strategy. In an enterprise that manages hundreds of thousands of drives and thousands of copy jobs per month, implementing such management techniques in the replication server 121 remain crucial to achieving near-best-possible throughput.

If a hard disk drive residing in the COPYING MISSING FILES state 570 cannot copy a file or, as discussed above, will compromise or threaten the overall speed of the corresponding job as determined by the replication server, the drive will incur a fault and take transition 574 to the FAIL state 540. For a “soft” fault, i.e., a fault unlikely to persist during a subsequent replication job and the drive has available retries then, the drive undertakes the transition 543 to return to the pool of drives in the AVAILABLE state 510. However, if the fault is one-too-many, or otherwise considered to be too severe, then with no retries remaining, the drive undertakes the transition 542 to MAINTENANCE state 505 for advanced testing, conditioning, and repair attempts.

Once the tasks occurring during of COPYING MISSING FILES state 570 have completed, the drive undertakes the transition 578 to the TESTING state 580. Various strategies for testing exist and during the TESTING state 580. The hard disk drive can undergo functional testing (e.g., execution of the drive operating system's ‘file system check’ command) or check summing of each content file and comparing it to a reference value (which may itself be included in the same or different content file), or a byte-by-byte comparison with the original content files, as deemed appropriate to sufficiently ensure that the structure of the drive's file system and integrity of the content data has been copied successfully or otherwise remains intact. The checksumming process has the advantage that testing of each hard disk drive can occur independently.

The test strategy can vary by job. Whatever the strategy, if a test fails, the hard disk drive undergoes the transition 584 to the FAIL state 540. If the testing returns success, then by way of transition 587, the hard disk drive enters the PASS state 590 and can undergo removal during the step 164 of FIG. 1. However, in the case when the drive's serial number remains unassociated with a known barcode during the step 305 of FIG. 3, then the hard disk drive undergoes the transition 581 to NEEDS BARCODE SCAN state 585, where the drive waits. (The corresponding indicator 206 of FIG. 2 can exhibit an urgent “scan my barcode” indication at this time.) Following a bar code scan (similar to the scanning discussed above in conjunction with FIG. 3), transition 588 is taken and the hard disk drive enters the PASS state 590, ready for removal 164. While in PASS state 590, the drive may be powered down by the system.

If, for some reason, a hard disk drive residing in the PASS state 590 is powered down but not removed by an operator and subsequently becomes powered up, the replication server 121 may recognize this event as the drive enters AVAILABLE state 510 and redirect the drive to undergo the transition 518 to the TESTING state 580 (or even directly to the PASS state 590). The replication server can undertake these steps to mitigate operator errors that could be reasonably expected to occur when handling thousands of drives.

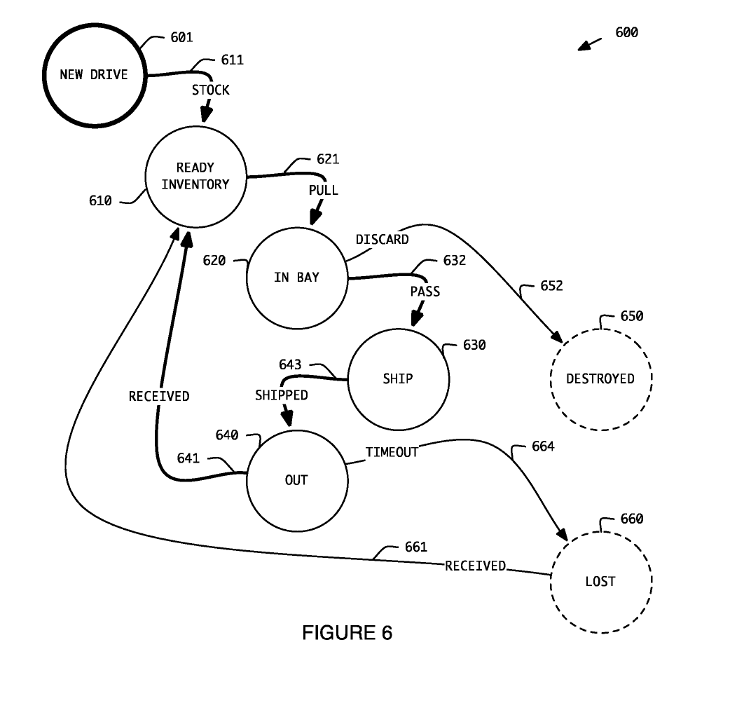

FIG. 6 shows an overall drive state transition diagram 600, in which the entirety of FIG. 5 is represented by IN BAY state 620. A newly acquired drive begins in NEW DRIVE state 601, during which the drive gets a barcode (e.g., the bar code 242), which the replication system 120 may or may not know. The new hard disk drive may get stocked during the transition 611 into one of the inbound inventories 140A or 140B of FIG. 1 as the default inventory for new drives, by scanning the drive with barcode scanner 132 so the drive now enters the READY INVENTORY state 610. During normal operations, an operator might pull the hard disk drive from inventory (e.g., 140A) during the transition 521 and insert the drive into replication array 123 during step 163 of FIG. 1. The hard disk drive now enters the IN BAY meta-state 620 corresponding to the EMPTY BAY state 501 of FIG. 5.

Upon detecting a hard disk drive, the replication server 121 of FIGS. 1 and 2 causes the drive to undergo the transition 502 of FIG. 5 to the AVAILABLE state 510 of FIG. 5 and processing proceeds according to the discussion regarding diagram 500, all while the hard disk drive remains in the IN BAY meta-state 620 of FIG. 6. Upon the hard disk drive reaching either of states 590 or 595 of FIG. 5, the replication system 120 awaits operator action before triggering the hard disk drive to transition out of the IN BAY meta-state 620. Once the hard disk drive enters the terminal DISCARD state 595, the replication server 121 signals an operator to discard the drive, so that upon removal from array 123, the hard disk dive undergoes the transition 652 to the DESTROYED state 650. (The replication server 121 presumes that the operator has placed the drive into a bin reserved for drives being crushed, or drilled, or otherwise handled according to the drive disposal policy). While a hard disk drive resides in the terminal state PASS 590, the replication server 121 signals an operator that the drive has become ready for shipment. Thus, when the operator removes the hard disk drive during step 164 and places the drive in the outbound inventory 150, the hard disk drive follows the transition 632 to the to SHIP state 630.

During step 165, of FIG. 1 an operator will pull a hard disk drive from the outbound inventory 150 and scan the drive barcode in order to print a shipping label 135 in connection with shipping the hard disk drive. Under such circumstances, the replication server 121 of FIGS. 1 and 2 will consider the hard disk drive as shipped so the drive undergoes the transition 643 of FIG. 6 to enter the OUT 640 state, even though actual shipping occurs during the step 166 of FIG. 1. In some example embodiments, the status OUT 640 can comprise different sub-states on the basis of information obtained from the logistics server operated by the shipping company (not shown). In such an embodiment, separate sub-states (for example, “AWAITING PICKUP”, “PICKED UP”, “IN ROUTE”, “DELIVERED”, “DELIVERY FAILED”, etc.) can exist included. In other example embodiments, the information obtained independently from the logistics server operated by the shipping company and associated with the shipping label 135 can uniquely identify the shipment and thereby be associated with the drive.

After a hard disk drive enters the OUT state 640, the recipient of that drive will usually return it after some amount of time (generally weeks). Therefore, upon receipt of a hard disk drive during step 161 of FIG. 1 and scanning of the drive with barcode restocking of the drive into the inbound inventory 140A or 140B during step 162, the drive undertakes takes the transition 641 of FIG. 6 and returns to the READY INVENTORY state 610. In some cases, where a drive has gone unreturned for an extraordinary amount of time (e.g., several months), its OUT status 640 may timeout during the transition 664 and the drive will enter the LOST 660. Designating a drive as lost have value for inventory management, to detect and track shrinkage, and may have value for tax purposes or for trigging an inquiry (or a bill) sent to the recipient of the missing drive. If, at some point, the missing hard disk drive unexpectedly and miraculously reappears, then via transition 661, the drive can return to the READY INVENTORY 610. For this reason, LOST state 660 does not necessarily constitute a terminal node in diagram 600, unless as a matter of business policy, once a drive considered lost it is never returned to use.

With respect to the system 100, the life cycle of a drive begins at 601 of FIG. 6 when first placed into stock during the transition 611. The hard disk drive then cycles repeatedly through the states 610, 620, 630, and 640, returning to the inventory state 610 until at some point (barring loss) many cycles later, the drive fails and gets destroyed.

The foregoing describes a system and method of use for replicating content onto a storage device.

1. A method for providing a storage device with content files, comprising the steps of:
identifying, from a work order, a needed set of content files;
selecting, from a storage device inventory, a storage device whose previously written content files most closely match the needed set of content files identified from the work order; and
adjusting the set of content files on the selected storage device so that the storage device stores at least the needed set of content files.

2. The method according to claim 1 wherein the selecting step comprises the steps of:
identifying each storage device within in the storage drive inventory;
determining, for each identified storage device, a list of content files previously written on to said each identified storage device, and
comparing the list of content files previously written onto said each identified storage device to the needed set of content files to select the identified storage device whose previously written files most closely match the needed set of content files identified from the work order.

3. The method according to claim 2 wherein the comparing step comprises the steps of
determining which of the needed set of content files has the largest size; and
determining whether the largest of the needed set of content files was previously written onto the storage device.

4. The method according to claim 1 wherein the selecting step comprises the steps of:
determining, for each storage device in the inventory of storage devices, an aggregate size of the set of needed content files not previously written to, and therefore missing from, said each storage device, and
selecting the storage device having a smallest aggregate size of the set of needed content missing therefrom.

5. The method according to claim 2 wherein the step of identifying each storage device comprises the step of scanning a bar code on the storage device corresponding to a device serial number.

6. The method according to claim 1 wherein the step of adjusting comprises the step of replicating onto the selected storage device those of the needed set of content files onto not previously written on the selected storage device.

7. The method according to claim 6 wherein the adjusting step comprises the step of deleting out-of-date content files on the selected storage device.

8. The method according to claim 1 further including the step of generating a shipping label with a destination determined in accordance with destination information specified in the work order.

9. The method according to claim 8 further including the step of shipping the selected storage device to a destination specified on the shipping label.

10. A method for providing a storage device with content files, comprising the steps of:
identifying, from a work order, a needed set of content files;
selecting, from a storage device inventory comprising at least first and second storage devices having previously written content files, the first storage device when the previously written content files on the first storage device more closely match the needed set of content files identified from the work order than the second storage device; and
adjusting the set of content files on the first storage device so that the first storage device stores at least the needed set of content files.

11. The method according to claim lo wherein the step of adjusting comprises the step of replicating onto the first storage device those of the needed set of content files onto not previously written on the first storage device.

12. The method according to claim 11 wherein the adjusting step comprises the step of deleting out-of-date content files on the first storage device.

13. A system for providing a storage device with content files, comprising,
a booking system for entering and storing at least work order specifying a needed set of content files for a storage device:
a replication system responsive to the work order for selecting, from a storage device inventory, a storage device whose previously written content files most closely match the needed set of content files identified from the at least one work order; and for adjusting the set of content files on the selected storage device so that the storage device stores at least the needed set of content files; and
a distribution system for distributing the selected storage device to a destination specified in the at least one work order.

14. The system according to claim 13 wherein the booking system comprises:
a booking server for receiving the at least one work order; and
a database for storing the at least one work order; and
a content store for storing content files for replication onto at least one storage device in accordance with the at least one work order.

15. The system according to claim 13 wherein the replication system comprises:
a replication server;
a storage device information database storing information about storage devices in the storage device inventory;
a replication array coupled to the replication server for holding at least one storage device;
the replication server adjusting content files on the at least one storage held in the replication array in accordance with a difference between the needed set of content files specified in the work order and existing content files previously written onto the at least one storage device, as determined from the storage device information database.

16. The system according to claim 13 wherein the distribution system comprises:
a reader for reading information the selected storage device;
a logistics server responsive to information from the reader identifying the selected storage de vice for accessing destination information corresponding to the identifying information for the selected storage device:
a label printer for printing a shipping label containing the destination information for the selected storage device.

17. Apparatus for providing a storage device with content files, comprising:
means for identifying, from a work order, a needed set of content files;
means for selecting, from a storage device inventory, a storage device whose previously written content files most closely match the needed set of content files identified from the work order; and
means for adjusting the set of content files on the selected storage device so that the storage device stores at least the needed set of content files.

18. The apparatus according to claim 17 wherein the selecting means comprises:
means for identifying each storage device within in the storage drive inventory;
means for determining, for each identified storage device, a list of content files previously written on to said each identified storage device, and
means for comparing the list of content files previously written onto said each identified storage device to the needed set of content files to select the identified storage device whose previously written files most closely match the needed set of content files identified from the work order.

19. The apparatus according to claim 17 wherein the selecting means comprises:
means for determining, for each storage device in the inventory of storage devices, an aggregate size of the set of needed content files not previously written to, and therefore missing from, said each storage device, and
means for selecting the storage device having a smallest aggregate size of the set of needed content missing therefrom.

20. The apparatus according to claim 13 wherein the adjusting means comprises means for replicating onto the selected storage device those of the needed set of content files onto not previously written on the selected storage devices.
